(19) United States
(12) Patent Application Publication
(10) Pub. No.: US 2017/0250400 A1
(43) Pub. Date: Aug. 31, 2017

(54) ELECTRODE WITH COATING LAYER AND LI-ION BATTERY INCLUDING THE SAME

(71) Applicant: CONTEMPORARY AMPEREX TECHNOLOGY CO., LIMITED, Ningde City (CN)

(72) Inventors: Dengjun AI, Ningde City (CN); Chuanmiao YAN, Ningde City (CN); Kaifu ZHONG, Ningde City (CN)

(21) Appl. No.: 15/429,083

(22) Filed: Feb. 9, 2017

(30) Foreign Application Priority Data
Feb. 26, 2016 (CN) 201610107629.5

(51) Int. Cl. H01M 4/36; H01M 10/0525; H01M 4/48; H01M 4/62; H01M 4/136; H01M 4/58; H01M 4/131; H01M 2/16

(52) U.S. Cl. CPC H01M 4/364; H01M 4/131; H01M 10/0525; H01M 2/1653; H01M 4/622; H01M 4/136; H01M 4/366; H01M 4/58; H01M 4/483

(57) ABSTRACT

An electrode with coating layer and a Li-ion battery including the electrode with coating layer are provided. The electrode with coating layer includes an electrode piece, a first material layer adjacent to the electrode piece, and a second material layer adjacent to the first material layer and far away from the electrode piece, the first material layer includes a first inorganic particle and a first binder, the second material layer includes a second binder, the first inorganic particle is at least one selected from a group consisting of metal hydroxide and boron-containing compound. The electrode with coating layer, under synergistic effect of the first material layer and the second material layer, can improve thermal stability and safety of the battery, under a situation that both the exterior and interior of the battery are at high temperature, the battery does not readily burn or explode.

### CROSS-REFERENCE TO RELATED APPLICATIONS

The present application claims priority to Chinese Patent Application No. 201610107629.5, filed on Feb. 26, 2016, the content of which is incorporated herein by reference in its entirety.

### TECHNICAL FIELD

The present application relates to the field of Li-ion batteries and, particularly, relates to an electrode with coating layer and a Li-ion battery including the electrode with coating layer.

### BACKGROUND

At present, since people have an increasing need on mobile phones, cameras, laptops, personal computers and electric vehicles, electrochemical devices have drawn great concern and, especially, the development of the rechargeable secondary battery has become the focus of interest, in which the evaluation and guarantee on battery safety are important issues to be considered. Particularly, injuries to users that are caused by faults of the battery should be avoided. Thus, safety of batteries in the aspect of fire and burning is strictly restricted by the safety standards. In the prior art, a plurality of manners have been used to solve the problems related to battery safety.

For example, flame retardant materials have been applied in batteries, which are mainly divided into flame retardant materials for electrolyte and flame retardant materials for electrodes. However, the flame retardant materials for electrolyte readily react with the component of the electrolyte, which therefore influences the performance of the battery; generally, it is hard for the flame retardant materials for electrodes to exert the flame retardant effect due to the mixing with active material, binder polymer and conductive agent in the slurry of the electrodes, which therefore will also influence the performance of the electrodes.

Additionally, in the existed Li-ion batteries at present, the polyolefin-based separator is used to prevent short circuit between the positive electrode and the negative electrode. However, the melting point of polyolefin-based polymer is no more than 200° C., which exhibits the deficiency of high thermal shrinkage when exposed in high temperature, that is to say, when the temperature of the battery increases due to internal factors and/or external factors, this type of separator may shrink or melt. Moreover, there is high probability of short circuit resulted from the direct contact of the positive electrode and the negative electrode due to the shrinkage or melting of the separator, which therefore readily causes accidents of batteries, such as burning or explosion, due to fast discharging.

In order to avoid the above-mentioned situations, people have done a lot of attempt, for example, coating on the polyolefin-based separator with inorganic particles containing alumina, silicon oxide and calcium carbonate and polymer binder, so as to prevent the polyolefin-based separator from thermal shrinking; or coating on the surface of the positive electrode piece and/or negative electrode piece with inorganic particles containing alumina, silicon oxide, calcium carbonate and polymer binder, so as to prevent short circuit between the positive electrode and negative electrode when the separator shrinks. However, these solutions cannot fundamentally solve the rapid heating problem after the short circuit between the positive electrode and negative electrode caused by external impact or internal impact; even if the separator would not thermally shrink at high temperature, there is still possibility of the occurrence of dangerous accidents, such as burning or explosion, at any time or under second impact.

### SUMMARY

In order to solve the above-mentioned problems, the applicant has done creative research, the result shows an electrode including an electrode piece, a first material layer adjacent to the electrode piece, and a second material layer adjacent to the first material layer, in which the first material layer includes a first inorganic particle and a first binder, the second material layer includes a second binder, such electrode can improve the thermal stability and safety of the battery, and then the present application is accomplished.

The object of the present application is to provide an electrode with coating layer, including an electrode piece, a first material layer adjacent to the electrode piece, and a second material layer adjacent to the first material layer and far away from the electrode piece, wherein the first material layer includes a first inorganic particle and a first binder, the second material layer includes a second binder, and the first inorganic particle is at least one selected from a group consisting of metal hydroxide and a boron-containing compound.

Another object of the present application is to provide a Li-ion battery, characterized in that, including a positive electrode, a negative electrode and a separator, wherein, the positive electrode and/or negative electrode is the electrode with coating layer provided by the present application.

The electrode with coating layer provided by the present application, due to the first material layer and the second material layer that are included, can improve the thermal stability and safety of the battery under the synergistic effect of the first material layer and the second material layer, for example, under the situation that both the exterior and interior of the Li-ion battery are at high temperature, the Li-ion battery does not readily burn or explode.

### DESCRIPTION OF EMBODIMENTS

The characteristics and advantages of the present application will become more clear and definite with the detailed description of the present application as follows.

The object of the present application is to provide an electrode with a coating layer, including a first material layer adjacent to the electrode piece and a second material layer adjacent to the first material layer and far away from the electrode piece, in which, the first material layer includes a first inorganic particle and a first binder, the second material layer includes a second binder. Particularly, the first material layer is adjacent to the second material layer.

In the following expressions, the expression “electrode with coating layer” may be abbreviated as “electrode”.

In the above-mentioned electrode, the expression “adjacent to the electrode piece” shall be interpreted to be located on the surface of the electrode piece or adjacent to the surface of the electrode piece but not in contact with the electrode piece; the expression “far away from the electrode piece” shall be interpreted to be located at the surface of the separator in the battery or adjacent to the surface of the separator but not in contact with the separator in the battery when the electrode is applied in the battery; the expression “the first material layer is adjacent to the second material layer” shall be interpreted as: the first material layer and the second material layer are opposite to each other, the second material layer is located on the first material layer, or the first material layer is located on the second material layer, wherein the two are located between the positive electrode piece and the separator and/or between the negative electrode piece and the separator when the first material layer and the second material layer are opposite to each other.

In the above-mentioned electrode, the first inorganic particle included in the first material layer is at least one selected from a group consisting of metal hydroxide and a boron-containing compound, wherein there is no limit on the specific types of the metal hydroxide and boron-containing compound, which can be selected according to actual demand. Preferably, the first inorganic particle is at least one selected from a group consisting of magnesium hydroxide, aluminum hydroxide, boehmite (γ-AlOOH), boric acid (H₃BO₃) and metaboric acid (HBO₂). The above-mentioned inorganic particles as selected, under the situation that the battery produces a large amount of heat, enable the first material layer to better discompose and absorb the heat that the battery produces, such that the battery can dissipate heat faster.

In the above-mentioned electrode, the specific type of the first binder included in the first material layer can be selected according to actual demand without particular limit. Preferably, the first binder is at least one selected from a group consisting of polyacrylic acid, polyacrylate, polyacrylonitrile and polyamide; further preferably, the first binder is at least one selected from a group consisting of polyacrylic acid, poly (methyl methacrylate), methyl methacrylate-ethyl methacrylate copolymer, methyl acrylate-ethyl methacrylate copolymer, methyl methacrylate-butyl methacrylate copolymer, methyl acrylate-butyl methacrylate copolymer, methyl acrylate-butyl acrylate copolymer, polyacrylonitrile and polyacrylamide. The selected first binder above not only plays a good role of binding, but also enables the electrolyte to have good wettability with respect to the first material layer, so as to further improve the performance of the Li-ion battery, such as thermal stability and safety.

The first inorganic particles are integrally formed into the first material layer together with the first binder, which, under the synergistic effect of the first inorganic particles and the first binder, not only enables the electrolyte to have good wettability with respect to the first material layer, but also enables the first material layer to absorb the heat generated in the interior of the battery, so as to make the battery dissipate heat rapidly, thereby improving the performance of battery, such as thermal stability and safety. For example, under the situation that both the interior and exterior of the battery are at high temperature, the battery does not readily burn or explode.

In the first material layer of the above-mentioned electrode, preferably, the content of the first inorganic particle is 70˜99.5% of the total weight of the first material layer, further preferably, the content of the first inorganic particle is 90˜99% of the total weight of the first material layer; the content of the first binder is 0.5˜30% of the total weight of the first material layer, such that the first binder in the above-mentioned weight range guarantees that the first material layer as a whole has better adhesion, further preferably, the content of the first binder is 1˜10% of the total weight of the first material layer.

In addition, the first material layer of the electrode further includes a thickener, the specific type of the thickener can be selected according to actual demand, for example, sodium carboxymethyl cellulose (CMC) can be added into the first material layer as a thickener. When the first material further includes the thickener, preferably, the content of the thickener is 0.1%˜5% of the total weight of the first material layer.

The thickness of the first material layer formed after coating and drying can be adjusted according to reasonable situation and actual demand, particularly, the thickness of the first material layer is 1˜10 μm, preferably 2˜6 μm.

In the second material layer of the electrode, there is no limit on the specific type of the second binder, which can be selected according to actual demand and reasonable situation. Preferably, the second binder includes polyvinylidene fluoride, polytetrafluoroethylene and a copolymer thereof, that is to say, the second binder may be at least one selected from a group consisting of the following copolymers: polyvinylidene fluoride-hexafluoropropylene copolymer (PVDF-HFP) and polyvinylidene fluoride-chlorotrifluoroethylene copolymer (PVDF-CTFE). With the second binder as mentioned above, the adhesion of the second binder increases when the internal temperature of the battery increases, therefore the second binder can still maintain excellent adhesion with the separator or the first material layer after the endothermic reaction of the inorganic particles in the first material layer occurs; besides, each material layer is guaranteed to be uniformly located between the electrode piece and the separator, which significantly prevents the deformation and cracking of the first material layer caused by the endothermic reaction of the inorganic particles, thus, the first material layer does not readily fall off, so as to reduce the occurrence of short circuit between the negative electrode and the positive electrode at high temperature and improve the safety of the battery, such that the battery does not readily burn or explode.

Besides, the second material layer may further includes polymer that can enhance the flexibility of the second material layer, interface adhesion and wettability of electrolyte with respect to the second material layer, such as styrene-acrylate copolymer, polypropylene acid, polyacrylonitrile and polyacrylate, etc. Further preferably, the second material layer may further include at least one of styrene-butyl acrylate copolymer, styrene-methyl acrylate copolymer, polypropylene acid, polyacrylonitrile, poly (butyl acrylate) and poly (butyl methacrylate), the content of the polymer that can improve performance of the second material layer is 1˜10% of the total weight of the second material layer. The second material layer may further include a thickener, such as sodium carboxymethyl cellulose (CMC), the content of the thickener is more than 0 and less than or equal to 3% of the total weight of the second material layer.

Additionally, the second material layer may include a second inorganic particle, the second inorganic particle can be metal oxide, the specific type of the second inorganic particle can be selected according to actual demand and reasonable situation, such as aluminum oxide (Al₂O₃) and silicon dioxide (SiO₂), the content of the second inorganic particle is 5˜70% of the total weight of the second material layer.

The thickness of the second material layer formed after coating and drying can be adjusted according to actual demand and reasonable situation, particularly, the thickness of the second material layer is 1˜10 μm, which enables the first material layer to play a better role in absorbing heat, further preferably, the thickness of the second material layer is 26 μm.

In the above-mentioned electrode, due to the first material layer and the second material layer that are included, with the synergistic effect of the first material layer and the second material layer, the thermal stability and safety of the battery can be improved. For example, under the situation that both the internal and external temperature of the battery are high, the battery does not readily burn or explode.

In the present application, the forming manner of each of the material layers on the electrode piece is not specifically limited, for example, the first material layer can be formed on the positive electrode piece or the negative electrode piece, and the second material layer is formed on the first material layer; or the first material layer is formed on the positive electrode piece or the negative electrode piece, and the second material layer is formed on the separator; or the second material layer is formed on the separator, and the first material layer is formed on the second material layer.

In the present application, there is no particular limit on the method for preparing the electrode. Conventional methods can be selected. For example, coating the slurry that can form the first material layer on the positive electrode piece or the negative electrode piece, and then coating the slurry that can form the second material layer on the first material layer or the separator; or coating the slurry that can form the second material layer on the separator, and then coating the slurry that can form the first material layer on the second material layer, wherein the coating methods are all conventional methods, as long as the slurry that forms the material layer is uniformly coated. The methods for preparing the slurry that forms the first material layer and the slurry that forms the second material layer are all conventional methods, for example, adding the material including the first inorganic particle and the first binder into a solvent, such as water, evenly mixing, so as to acquire the slurry that can form the first material layer, and then sequentially coating the slurry and drying, so as to form the first material layer. Similarly, adding the material including the second binder into a solvent, such as water, evenly mixing, so as to form the slurry that can forms the second material layer, and then sequentially coating the slurry and drying, so as to form the second material layer.

Another object of the present application is to provide a Li-ion battery, including a positive electrode, a negative electrode and a separator, in which, the positive electrode and/or negative electrode is the electrode with coating layer provided by the present application, and the separator is located between the positive electrode and negative electrode.

In the above-mentioned Li-ion battery, the separator can be the conventional polyolefin separator, such as polyethylene separator, polypropylene separator or polyolefin separator with a coating layer on the surface, the coating layer includes a third binder and a third inorganic particle, and the third binder is one selected from a group consisting of poly(ethylene oxide), polyurethane, polyacrylonitrile, polyacrylate and copolymers formed via polymerizing of at least two monomers thereof, the third inorganic particle is at least one selected from a group consisting of silicon dioxide (SiO₂), aluminum oxide (Al₂O₃), calcium carbonate (CaCO₃), titanium dioxide (TiO₂), magnesium oxide (MgO) and boehmite (γ-AlOOH).

Since the above-mentioned Li-ion battery includes the electrode with coating layer provided by the present application, and the electrode with coating layer includes the first material layer and the second material layer, under the synergistic effect of the first material layer and the second material layer, the thermal stability and safety of the Li-ion battery can be improved. For example, under the situation that both the internal and external temperature of the battery are high, the Li-ion battery does not readily burn or explode.

### EMBODIMENTS

The present application is described in further detail through the following embodiments which are merely exemplary and do not constitute any limit to the protection scope of the present application.

In the following embodiments, comparison examples and experimental examples, if no particular specification, the used materials, agents and apparatus are all conventional materials that can be obtained from commercial approaches, or the agents thereof can be obtained by synthetizing in a conventional manner.

Preparation of Li-Ion Batteries (Abbreviated as Battery) in Embodiments 1˜7

I. Preparing Positive Electrodes, Negative Electrodes and Electrolyte in Embodiments 1˜7 According to the Following Method:

(1) Preparation of the Positive Electrode Piece

Mixing a positive electrode active material of Lithium cobaltate (LiCoO₂), a conductive agent of conductive carbon black Super-P, a binder of polyvinylidene fluoride (PVDF) in a weight ratio of LiCoO₂:Super-P:PVDF=96:2:2, adding the mixed materials to N-methyl pyrrolidone (NMP) and evenly mixing, so as to obtain positive electrode slurry; coating the positive electrode slurry on a positive electrode current collector of an aluminum foil, drying at 85° C., cold pressing, and then cutting edge, slitting, stripping, and then drying for 4 h in vacuum at 85° C., welding electrode tabs, so as to obtain the positive electrode piece.

(2) Preparation of the Negative Electrode Piece

Mixing a negative electrode active material of graphite, a conductive agent of conductive carbon black Super-P, a thickener of sodium carboxymethyl cellulose (CMC), a binder of poly (styrene-co-butadiene) (SBR) in a mass ratio of graphite:Super-P:CMC: BR=96.5:1.0:1.0:1.5, adding the mixed materials to deionized water and evenly mixing, so as to obtain negative positive slurry; coating the negative positive slurry on a negative electrode current collector of a copper foil, drying at 85° C., and then cutting edge, slitting, stripping, and then drying for 4 h in vacuum at 110° C., welding electrode tabs, so as to obtain the negative electrode piece.

(3) Preparation of the Electrolyte

Mixing ethylene carbonate (EC), propylene carbonate (PC) and diethyl carbonate (DEC) in a weight ratio of EC:PC:DEC=30:30:40, so as to obtain a non-aqueous organic solvent; adding a lithium salt of lithium hexafluorophosphate (LiPF₆) in the non-aqueous organic solvent, so as to obtain the electrolyte, in which, the concentration of the lithium salt is 1 mol/L.

### Embodiment 1: Preparation of Battery 1

(1) Mixing a first inorganic particle of Al(OH)₃, a first binder of poly (methyl methacrylate), a thickener of sodium carboxymethyl cellulose (CMC) in a weight ratio of Al(OH)₃:first binder:CMC=98:1:1, and then adding the mixed materials to deionized water and evenly mixing, so as to obtain slurry of a first material layer; coating the obtained slurry of the first material layer on the surface of the negative electrode piece prepared as above, then drying, so as to form a first material layer, upon measurement, the thickness of the first material layer is 3 μm;

(2) Mixing a second binder of polyvinylidene fluoride and polyacrylonitrile in a weight ratio of polyvinylidene fluoride:polyacrylonitrile=90:10, adding the mixed materials to deionized water and evenly mixing, so as to obtain slurry of a second material layer; coating the obtained slurry of the second material layer on the surface of polyethylene separator, then drying, so as to form a second material layer, upon measurement, the thickness of the second material layer is 3 μm; the formed second material layer and the prepared first material layer are opposite to each other, and the first material layer and the second material layer are located between the negative electrode piece and the separator;

(3) Coiling the positive electrode piece, the negative electrode piece coated with the first material layer and polyethylene separator coated with the second material layer prepared as above, baking for 10 h in vacuum at 75° C., and then injecting the electrolyte prepared as above, standby for 24 h, charging to 4.2V with a constant current of 0.1 C (160 mA), charging to 0.05 C (80 mA) with a constant voltage of 4.2V, and then discharging to 3.0V with a constant current of 0.1 C (160 mA), repeating the charging and discharging process twice, finally charging the battery to 3.85V with a constant current of 0.1 C (160 mA), so as to obtain Battery 1 with a thickness of 4.2 mm, a width of 34 mm and a length of 82 mm.

### Embodiment 2: Preparation of Battery 2

Repeating the preparation of Battery 1 in Embodiment 1, in which, the first inorganic particle Al(OH)₃ is replaced by boehmite (γ-AlOOH) and other conditions are not changed, so as to obtain Battery 2 with a thickness of 4.2 mm, a width of 34 mm, and a length of 82 mm.

### Embodiment 3: Preparation of Battery 3

Repeating the preparation of Battery 1 in Embodiment 1, in which, the first inorganic particle Al(OH)₃ is replaced by boric acid (H₃BO₃) and other conditions are not changed, so as to obtain Battery 3 with a thickness of 4.2 mm, a width of 34 mm, and a length of 82 mm.

### Embodiment 4: Preparation of Battery 4

(1) Mixing a first inorganic particle of Al(OH)₃, a first binder of polyacrylonitrile, a thickener of sodium carboxymethyl cellulose (CMC) in a weight ratio of Al(OH)₃:first binder:CMC=98:1:1, and then adding the mixed materials to deionized water and evenly mixing, so as to obtain slurry of a first material layer; coating the obtained slurry of a first material layer on the surface of the negative electrode piece prepared as above, then drying, so as to form a first material layer, upon measurement, the thickness of the first material layer is 3 μm;

(2) Mixing a second binder of polyvinylidene fluoride-hexafluoropropylene (PVDF:HFP) to deionized water and evenly mixing, so as to obtain slurry of a second material layer; coating the obtained slurry of a second material layer on the surface of the obtained first material layer, then drying, so as to form a second material layer, according to the result of measurement, the thickness of the second material layer is 3 μm; the formed second material layer is located on the prepared first material layer;

(3) Coiling the positive electrode piece, the negative electrode piece coated with the first material layer and the second material layer, and the polyethylene separator, baking for 10 h in vacuum at 75° C., and then injecting the electrolyte prepared as above, standby for 24 h, charging to 4.2V with a constant current of 0.1 C (160 mA), charging to 0.05 C (80 mA) with a constant voltage of 4.2V, and then discharging to 3.0V with a constant current of 0.1 C (160 mA), repeating the charging and discharging process twice, finally charging the battery to 3.85V with a constant current of 0.1 C (160 mA), so as to obtain Battery 4 with a thickness of 4.2 mm, a width of 34 mm and a length of 82 mm.

### Embodiment 5: Preparation of Battery 5

(1) Mixing a second binder of polyvinylidene fluoride and polyacrylonitrile in a weight ratio of polyvinylidene fluoride:polyacrylonitrile=90:10, adding the mixed materials to deionized water and evenly mixing, so as to obtain slurry of a second material layer; coating the obtained slurry of a second material layer on the surface of polyethylene separator, then drying, so as to form a second material layer, upon measurement, the thickness of the second material layer is 3 μm;

(2) Mixing a first inorganic particle of Al(OH)₃, a first binder of poly(methyl methacrylate), a thickener of sodium carboxymethyl cellulose (CMC) in a weight ratio of Al(OH)₃:first binder:CMC=98:1:1, and then adding the mixed materials to deionized water and evenly mixing, so as to obtain slurry of a first material layer; coating the obtained slurry of a first material layer on the surface of the second material layer prepared as above, then drying, so as to form a first material layer, upon measurement, the thickness of the first material layer is 3 μm; the formed first material layer is located on the prepared second material layer;

(3) Coiling the positive electrode piece, the negative electrode piece, and the polyethylene separator coated with the first material layer and the second material layer, baking for 10 h in vacuum at 75° C., and then injecting the electrolyte prepared as above, standby for 24 h, charging to 4.2V with a constant current of 0.1 C (160 mA), charging to 0.05 C (80 mA) with a constant voltage of 4.2V, and then discharging to 3.0V with a constant current of 0.1 C (160 mA), repeating the charging and discharging process twice, finally charging the battery to 3.85V with a constant current of 0.1 C (160 mA), so as to obtain Battery 5 with a thickness of 4.2 mm, a width of 34 mm and a length of 82 mm.

### Embodiment 6: Preparation of Battery 6

(1) Mixing a first inorganic particle of Al(OH)₃, a first binder of poly(methyl methacrylate), a thickener of sodium carboxymethyl cellulose (CMC) in a weight ratio of Al(OH)₃:first binder: CMC=98:1:1, and then adding the mixed materials to deionized water and evenly mixing, so as to obtain slurry of a first material layer; coating the obtained slurry of a first material layer on the surface of the negative electrode piece prepared as above, then drying, so as to form a first material layer, upon measurement, the thickness of the first material layer is 3 μm;

(2) mixing metal oxide of Al₂O₃, a second binder of polyvinylidene fluoride, polyacrylic acid, a thickener of sodium carboxymethyl cellulose (CMC) in a weight ratio of Al₂O₃:second binder:polyacrylic acid: CMC=60:30:7:3, adding the mixed materials to deionized water and evenly mixing, so as to obtain slurry of a second material layer; coating the obtained slurry of a second material layer on the surface of polyethylene separator, then drying, so as to form a second material layer, upon measurement, the thickness of the second material layer is 4 μm; the formed second material layer and the prepared first material layer are opposite to each other, and the first material layer and the second material layer are located between the negative electrode piece and the separator;

(3) coiling the positive electrode piece, the negative electrode piece coated with the first material layer, and the separator of polyethylene coated with the second material layer, baking for 10 h in vacuum at 75° C., and then injecting the electrolyte prepared as above, standby for 24 h, charging to 4.2V with a constant current of 0.1 C (160 mA), charging to 0.05 C (80 mA) with a constant voltage of 4.2V, and then discharging to 3.0V with a constant current of 0.1 C (160 mA), repeating the charging and discharging twice, finally charging the battery to 3.85V with a constant current of 0.1 C (160 mA), so as to obtain Battery 6 with a thickness of 4.2 mm, a width of 34 mm and a length of 82 mm.

### Embodiment 7: Preparation of Battery 7

(1) Mixing a first inorganic particle of Al(OH)₃, a first binder of polyacrylonitrile, a thickener of sodium carboxymethyl cellulose (CMC) in a weight ratio of Al(OH)₃:first binder:CMC=98:1:1, adding the mixed materials to deionized water and evenly mixing, so as to obtain slurry of a first material layer; coating the obtained slurry of a first material layer on the surface of the positive electrode piece prepared as above, drying, so as to form a first material layer, upon measurement, the thickness of the first material layer is 3 μm;

(2) Mixing a second binder of polyvinylidene fluoride and polyacrylonitrile in a weight ratio of polyvinylidene fluoride:polyacrylonitrile=90:10, adding the mixed materials to deionized water and evenly mixing, so as to obtain slurry of a second material layer; coating the obtained slurry of a second material layer on the surface of the first material layer obtained as above, drying, so as to form a second material layer, upon measurement, the thickness of the second material layer is 3 μm; the formed second material layer is located on the prepared first material layer;

(3) Mixing a third inorganic particle of metal oxide of Al₂O₃, a third binder of polyacrylic acid, a thickener of sodium carboxymethyl cellulose (CMC) in a weight ratio of Al₂O₃:polyacrylic acid:CMC=90:8.5:1.5, adding the mixed materials to deionized water, evenly mixing, coating obtained slurry on the surface of polyethylene separator and drying, so as to form a polyethylene separator with a coating layer;

(4) Coiling the positive electrode piece coated with the first material layer and the second material layer, the negative electrode piece prepared as above and the separator of polyethylene with the coating layer, baking for 10 h in vacuum at 75° C., and then injecting the electrolyte prepared as above, standby for 24 h, charging to 4.2V with a constant current of 0.1 C (160 mA), charging to 0.05 C (80 mA) with a constant voltage of 4.2V, and then discharging to 3.0V with a constant current of 0.1 C (160 mA), repeating the charging and discharging process twice, finally charging the battery to 3.85V with a constant current of 0.1 C (160 mA), so as to obtain Battery 7 with a thickness of 4.2 mm, a width of 34 mm and a length of 82 mm.

### Comparative Examples 1˜4 Li-Ion Batteries (Abbreviated as Battery) 1^{#}˜4^{#}

### Comparative Example 1: Preparation of Battery 1^{#}

Repeating the preparation of Battery 1 in Embodiment 1, in which, the negative electrode piece is not coated with the slurry of the first material layer, and the polyethylene separator is not coated with the slurry of the second material layer, other conditions are not changed, so as to obtain Battery 1^{#} with a thickness of 4.2 mm, a width of 34 mm and a length of 82 mm.

### Comparative Example 2: Preparation of Battery 2^{#}

Repeating the preparation of Battery 1 in Embodiment 1, in which, the negative electrode piece is coated with slurry of the first material layer containing the following components: a first inorganic particle of Al₂O₃, a first binder of polyacrylate and a thickener of sodium carboxymethyl cellulose (CMC) in a weight ratio of Al₂O₃:first binder:CMC=98:1:1, other conditions are not changed, so as to obtain Battery 2^{#} with a thickness of 4.2 mm, a width of 34 mm and a length of 82 mm.

### Comparative Example 3: Preparation of Battery 3^{#}

Repeating the preparation of Battery 1 in Embodiment 1, in which, only the negative electrode piece is coated with the slurry of the first material layer, and the polyethylene separator is not coated with any material layer, other conditions are not changed, so as to obtain Battery 3^{#} with a thickness of 4.2 mm, a width of 34 mm and a length of 82 mm.

### Comparative Example 4: Preparation of Battery 4^{#}

Repeating the preparation of Battery 6 in Embodiment 6, in which, only the polyethylene separator is coated with the slurry of the first material layer, and the negative electrode piece is not coated with any material layer, other conditions are not changed, so as to obtain Battery 4^{#} with a thickness of 4.2 mm, a width of 34 mm and a length of 82 mm.

### Experimental Examples

(1) Safety Performance Test

The safety performance of the batteries is characterized by the nailing test.

The following tests are carried out respectively for the prepared batteries in the Embodiments and the Comparative examples:

Nailing through the whole battery with a high temperature resistant steel needle of 3 mm diameter (the conic angle of the needle tip is 45°), and then observing the status of the battery (5 batteries for each group, counting for the 5 batteries), the result is shown in Table 1, in which the nailing speed is set to be 80 mm/s.

(2) Thermal Stability Test

The thermal stability of the battery is characterized by the hot-box experiment.

The following tests are carried out respectively for the prepared batteries in the Embodiments and Comparative examples:

Placing the battery in a hot box, the temperature of the hot box is set at 150° C., standby for 2 h at a constant temperature, and then observing the status of the battery (5 batteries for each group, counting for the 5 batteries), the result is shown in Table 1.

TABLE 1

| Battery | Safety test | Thermal stability test |
|---|---|---|
| No. | Status in the nailing test | Status in the hot-box test |
| Battery 1 | No burning or explosion for 3 batteries | No burning or explosion for 4 batteries in the |
| | in the 5 batteries | 5 batteries |
| Battery 2 | No burning or explosion for 2 batteries | No burning or explosion for 2 batteries in the |
| | in the 5 batteries | 5 batteries |
| Battery 3 | No burning or explosion for 2 batteries | No burning or explosion for 2 batteries in the |
| | in the 5 batteries | 5 batteries |
| Battery 4 | No burning or explosion for 3 batteries | No burning or explosion for 3 batteries in the |
| | in the 5 batteries | 5 batteries |
| Battery 5 | No burning or explosion for 2 batteries | No burning or explosion for 3 batteries in the |
| | in the 5 batteries | 5 batteries |
| Battery 6 | No burning or explosion for 4 batteries | No burning and explosion for all the 5 batteries |
| | in the 5 batteries | |
| Battery 7 | No burning or explosion for all the | No burning and explosion for all the 5 batteries |
| | 5 batteries | |
| Battery 1^{#} | Burning and explosion for all the | Burning and explosion for all the 5 batteries |
| | 5 batteries | |
| Battery 2^{#} | No burning or explosion for 1 battery, | No burning or explosion for 1 battery, burning |
| | burning and explosion for all the rest 4 | and explosion for all the rest 4 batteries |
| | batteries | |
| Battery 3^{#} | No burning or explosion for 1 battery, | No burning or explosion for 1 battery, burning |
| | burning and explosion for all the rest 4 | and explosion for all the rest 4 batteries |
| | batteries | |
| Battery 4^{#} | No burning or explosion for 1 battery, | No burning or explosion for 1 battery, burning |
| | burning and explosion for all the rest 4 | and explosion for all the rest 4 batteries |
| | batteries | |

Based on the relevant results in Table 1, it can be obtained that:

In Embodiments 1˜7, the first material layer and the second material layer are arranged between the negative electrode piece and the separator or between the positive electrode piece and the separator, the first material layer contains the first inorganic particle, such as metal hydroxide and boron-containing compound; when the battery generates a large amount of heat, the heat generated by the battery can be absorbed by the selected first inorganic particle as mentioned above, so as to speed up the dissipation of heat of the battery; the second material layer contains polyvinylidene fluoride which has excellent adhesion, such that the first inorganic particle in the first material layer adjacent to the negative electrode piece or the positive electrode piece can still maintain good adhesion with the separator after endothermal reaction, so as to guarantee that each of the material layers is uniformly arranged between the positive electrode piece and/or the negative electrode piece and the separator, thereby preventing the first material layer from deforming or cracking after absorbing heat, reducing the possibility of short circuit between the negative electrode piece and the positive electrode piece, and significantly improving safety and thermal stability of the battery.

In Comparative example 1, there is no material layer arranged, under the nailing test and the hot-box test, the separator cracks or shrinks, which readily causes short circuit between the positive electrode piece and the negative electrode piece, thereby leading to burning and explosion of the battery; in Comparative example 2, the inorganic particle of Al₂O₃ is coated, which can play a certain role of absorbing the heat though, but cannot absorb the heat and reduce the temperature in time when high temperature is generated at the nailing point and the high-temperature hot-box test is performed, thus readily cause burning and explosion of the battery; in Comparative example 3, the surface of the negative electrode piece is only coated with the first material layer which can absorb heat at high temperature, however, Al(OH)₃ will generate new inorganic particles after the endothermal reaction occurs, and there is no second material layer, such that the first material layer deforms or cracks, the material layer readily falls off, and the separator shrinks, which increases the possibility of short circuit between the positive electrode piece and the negative electrode piece, thereby readily causing burning and explosion of the battery; in Comparative example 4, only the surface of the polyethylene separator is coated with the second material layer, which improves high-temperature resistance of the separator, however, there is no occurrence of the phenomenon of absorbing heat, such that the heat cannot be absorbed to reduce the temperature in time when high temperature is generated at the nailing point or the high-temperature hot-box test is performed, thus readily cause burning or explosion of the battery.

Compared with Embodiment 1, the inorganic particle of Al₂O₃ is added into the second material layer in Embodiment 6, which improves high-temperature resistance of the separator. The effect of Embodiment 6 is better than that of Embodiment 1.

Comparing Embodiments 1 and 7, the first material layer containing the first inorganic particle and the first binder, the second material layer containing the second binder, as well as the polyethylene separator coated with a layer containing the third inorganic particle and the third binder are provided in Embodiment 7, i.e., the first material layer that has heat absorbing effect, the coating layer of the separator that prevents the positive electrode piece and the negative electrode piece from short circuit, as well as the second material layer that enhances the adhesion of the first material layer and the coating layer of the separator are provided, thereby significantly improving safety and thermal stability of the battery.

Accordingly, in the electrodes provided by the present application, due to the first material layer and the second material layer that are included, under the synergistic effect of the first material layer and the second material layer, thermal stability and safety of the battery can be improved, for example, under the situation that both the exterior and interior of the Li-ion battery are at high temperature, the Li-ion battery does not readily burn or explode.

Based on the disclosure of the description above, the person skilled in the art can also make appropriate alternations and modifications to the above-mentioned embodiments. Thus, the present application is not limited to the embodiments as disclosed or described above, modifications and alternations to the present application shall also fall into the protection scope of the claims of the present application.

What is claimed is:

1. An electrode with coating layer, comprising an electrode piece, a first material layer adjacent to the electrode piece, and a second material layer adjacent to the first material layer and far away from the electrode piece, wherein the first material layer comprises a first inorganic particle and a first binder, the second material layer comprises a second binder, and the first inorganic particle is at least one selected from a group consisting of metal hydroxide and a boron-containing compound.

2. The electrode with coating layer according to claim 1, wherein the first inorganic particle is at least one selected from a group consisting of magnesium hydroxide, aluminum hydroxide, boehmite, boric acid and metaboric acid.

3. The electrode with coating layer according to claim 1, wherein the first binder is at least one selected from a group consisting of polyacrylic acid, polyacrylate, polyacrylonitrile and polyamide.

4. The electrode with coating layer according to claim 1, wherein the first binder is at least one selected from a group consisting of polyacrylic acid, poly(methyl methacrylate), methyl methacrylate-ethyl methacrylate copolymer, methyl acrylate-ethyl methacrylate copolymer, methyl methacrylate-butyl methacrylate copolymer, methyl acrylate-butyl methacrylate copolymer, methyl acrylate-butyl acrylate copolymer, polyacrylonitrile and polyacrylamide.

5. The electrode with coating layer according to claim 1, wherein a content of the first inorganic particle is 70˜99.5% of a total weight of the first material layer, a content of the first binder is 0.5˜30% of the total weight of the first material layer.

6. The electrode with coating layer according to claim 1, wherein the second binder comprises polyvinylidene fluoride, polytetrafluoroethylene and a copolymer thereof.

7. The electrode with coating layer according to claim 1, wherein the second material layer further comprises at least one of styrene-acrylate copolymer, polypropylene acid, polyacrylonitrile and polyacrylate; and/or the second material layer further comprises a second inorganic particle.

8. The electrode with coating layer according to claim 1, wherein a thickness of the first material layer is 1˜10 μm, a thickness of the second material layer is 1˜10 μm.

9. A Li-ion battery, comprising a positive electrode, a negative electrode and a separator, wherein the electrode with coating layer according to claim 1 is the positive electrode and/or the negative electrode.

10. The Li-ion battery according to claim 9, wherein the separator is a polyolefin separator or a polyolefin separator with a coating layer on a surface of the polyolefin separator, the coating layer comprises a third binder and a third inorganic particle, the third inorganic particle is at least one selected from a group consisting of silicon dioxide, aluminum oxide, calcium carbonate, titanium dioxide, magnesium oxide and boehmite.
